(19) United States
(12) Patent Application Publication
(10) Pub. No.: US 2024/0367056 A1
(43) Pub. Date: Nov. 7, 2024

(54) GAME PLAYER MODEL USE PROVISION APPARATUS

(71) Applicant: NEC Corporation, Minato-ku, Tokyo (JP)

(72) Inventors: Naoki YOSHINAGA, Tokyo (JP); Shinichi TOKUYAMA, Tokyo (JP); Noritaka SHIMURA, Tokyo (JP); Mitsuhiro KOBUNGYOU, Tokyo (JP); Ryota NAKAGAWA, Tokyo (JP)

(73) Assignee: NEC Corporation, Minato-ku, Tokyo (JP)

(21) Appl. No.: 18/687,422

(22) PCT Filed: Sep. 10, 2021
(86) PCT No.: PCT/JP2021/033374

§ 371 Date: Feb. 28, 2024

(51) Int. Cl. A63F 13/67; G06N 3/0895

(52) U.S. Cl. CPC A63F 13/67; G06N 3/0895

(57) ABSTRACT

A game player model use provision apparatus includes: an accepting means that accepts a use instruction to make a game player model available, the game player model having learned an action of a learning target in a second play state based on play data including a first play state in a game and an action taken by a player in the first play state and based on a label indicating whether or not to be a learning target; and an output means that outputs model information for using the game player model in response to the use instruction.

### TECHNICAL FIELD

The present invention relates to a game player model use provision apparatus, a game player model use provision method, and a recording medium.

### BACKGROUND ART

In various games including board games such as Go and Shogi and computer games such as fighting games and shooting games, computers may control characters and the like.

One of the techniques used for such control by computer is described in, for example, Patent Literature 1. Patent Literature 1 describes a learning apparatus for a fighting game that includes a storing unit for storing various programs and data, and a control unit for controlling the motions of a plurality of characters appearing in the fighting game based on the state of an operation by an input operation unit and the programs stored in the storing unit. According to Patent Literature 1, the control unit collects operation data related to tricks performed by the characters in response to operations by the input operation unit and screen state data related to screen display at predetermined timings, and executes a learning program to write the screen state data collected at the predetermined timings into a learning data storing unit. Then, the control unit optimizes the weight of a learning result by performing a deep learning calculation process based on the screen state data stored in the learning data storing unit.

### CITATION LIST

### Patent Literature

Patent Literature 1: Japanese Unexamined Patent Application Publication No. JP-A 2019-195512

### Non-Patent Literature

Non-Patent Literature 1: Lu Wang, and 8 others, “Adversarial Cooperative Imitation Learning for Dynamic Treatment Regimes”, [online], Apr. 20-24, 2020, Proceedings of The Web Conference 2020, [searched on Sep. 8, 2021], Internet <URL: https://dl.acm.org/doi/10.1145/3366423.3380248>

### SUMMARY OF INVENTION

### Technical Problem

In order to perform more proper learning corresponding to a learning target, such as more human-like, it is desirable to perform imitation learning as described in Patent Literature 1 rather than reinforcement learning in which a learner learns through his/her own action, but a large number of histories of play data and the like are necessary for properly performing imitation learning. However, in the case of simply collecting play data corresponding to operations by players as described in Patent Literature 1, it is difficult to collect enough play data necessary for imitation learning. As a result, a problem occurs that it is difficult to provide a model having learned appropriately for a learning target such as a computer player's operation close to a human operation.

Accordingly, an object of the present invention is to provide a server apparatus, a model provision method and a recording medium that can solve the problem that it is difficult to provide a model having learned appropriately for a learning target such as a computer player's operation close to a human operation.

### Solution to Problem

In order to achieve the object, a game player model use provision apparatus as an aspect of the present disclosure includes: an accepting means that accepts a use instruction to make a game player model available, the game player model having learned an action of a learning target in a second play state based on play data including a first play state in a game and an action taken by a player in the first play state and based on a label indicating whether or not to be a learning target: and an output means that outputs model information for using the game player model in response to the use instruction.

Further, a game player model use provision method as another aspect of the present disclosure is a game player model use provision method by an information processing apparatus, including: accepting a use instruction to make a game player model available, the game player model having learned an action of a learning target in a second play state based on play data including a first play state in a game and an action taken by a player in the first play state and based on a label indicating whether or not to be a learning target: and outputting model information for using the game player model in response to the use instruction.

Further, a recording medium as another aspect of the present disclosure is a non-transitory computer-readable recording medium on which a program is recorded, and the program includes instructions for causing an information processing apparatus to realize processes to: accept a use instruction to make a game player model available, the game player model having learned an action of a learning target in a second play state based on play data including a first play state in a game and an action taken by a player in the first play state and based on a label indicating whether or not to be a learning target: and output model information for using the game player model in response to the use instruction.

### Advantageous Effects of Invention

According to the respective configurations as described above, it is possible to provide a game player model use provision apparatus, a game player model use provision method and a recording medium that can provide a model having favorably learned so as to get close to a learning target, for example, so as to bring a computer player's operation closer to a human operation.

### BRIEF DESCRIPTION OF DRAWINGS

FIG. 1 is a view for describing a learning apparatus in a first example embodiment of the present disclosure.

FIG. 2 is a block diagram showing an example of the configuration of the learning apparatus.

FIG. 3 is a view showing an example of input data shown in FIG. 2.

FIG. 4 is a view for describing an example of an attribute.

FIG. 5 is a view showing an example of play data to be collected.

FIG. 6 is a view showing another example of the play data.

FIG. 7 is a view for describing another example of the play data.

FIG. 8 is a view for describing an example of a learning process.

FIG. 9 is a flowchart showing an example of the operation of the learning apparatus.

FIG. 10 is a block diagram showing another example of the configuration of the learning apparatus.

FIG. 11 is a view for describing an example of audio information.

FIG. 12 is a view showing an example of the configuration of a learning system in a second example embodiment of the present disclosure.

FIG. 13 is a block diagram showing an example of the configuration of a customer device shown in FIG. 10.

FIG. 14 is a block diagram showing an example of the configuration of a server apparatus shown in FIG. 10.

FIG. 15 is a view for describing an example of a charging process.

FIG. 16 is a view for describing another example of the charging process.

FIG. 17 is a flowchart showing an example of the operation of the server apparatus.

FIG. 18 is a flowchart showing an example of the operation of the server apparatus.

FIG. 19 is a block diagram showing an example of the hardware configuration of a gameplay operation learning apparatus in a third example embodiment of the present disclosure.

FIG. 20 is a block diagram showing an example of the configuration of the gameplay operation learning apparatus.

FIG. 21 is a block diagram showing an example of the configuration of a game player model use provision apparatus in a fourth example embodiment of the present disclosure.

### DESCRIPTION OF EXAMPLE EMBODIMENTS

### First Example Embodiment

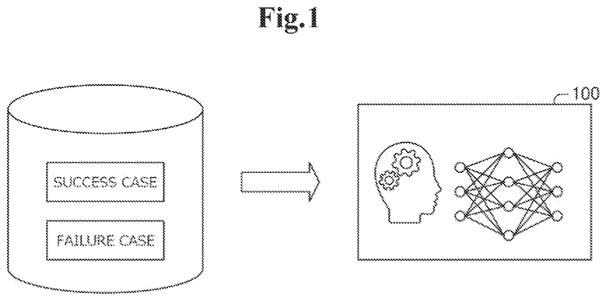

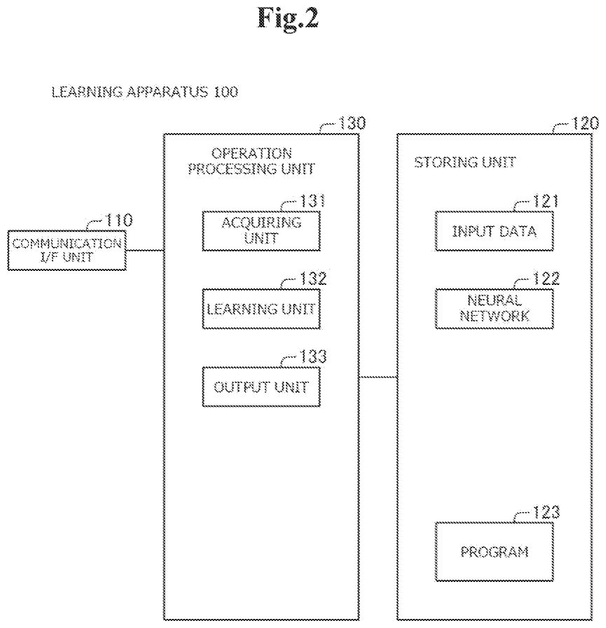

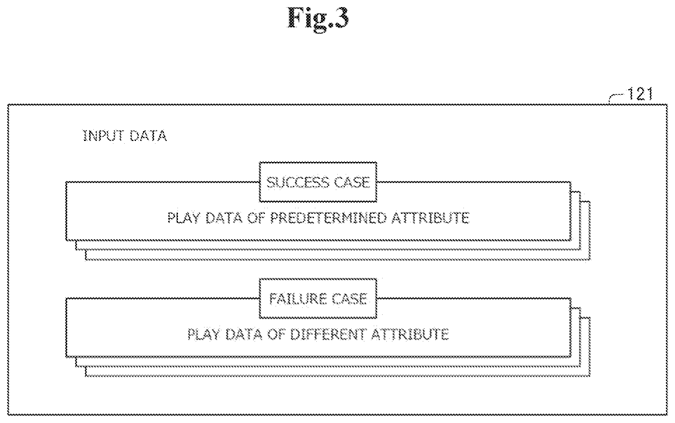

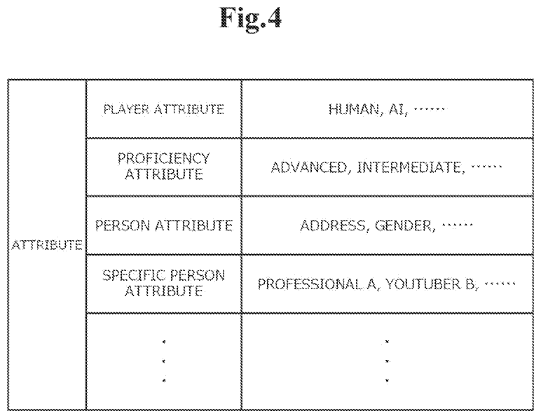

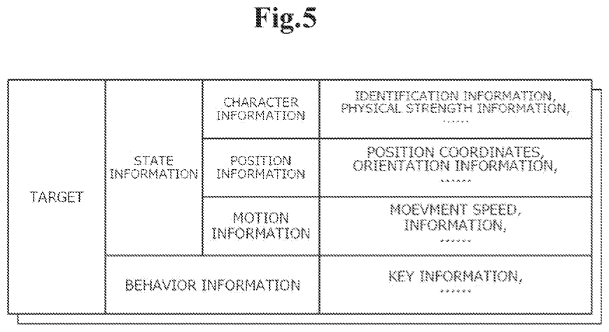

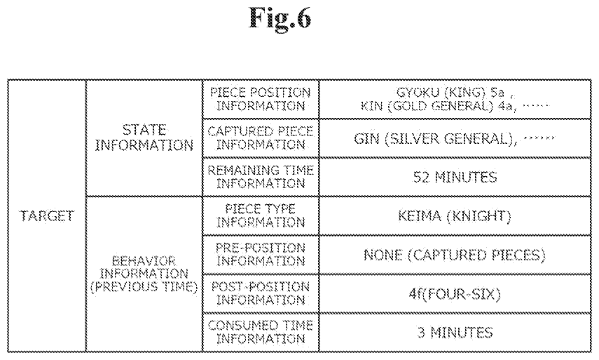

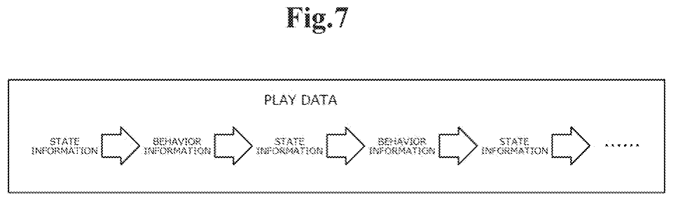

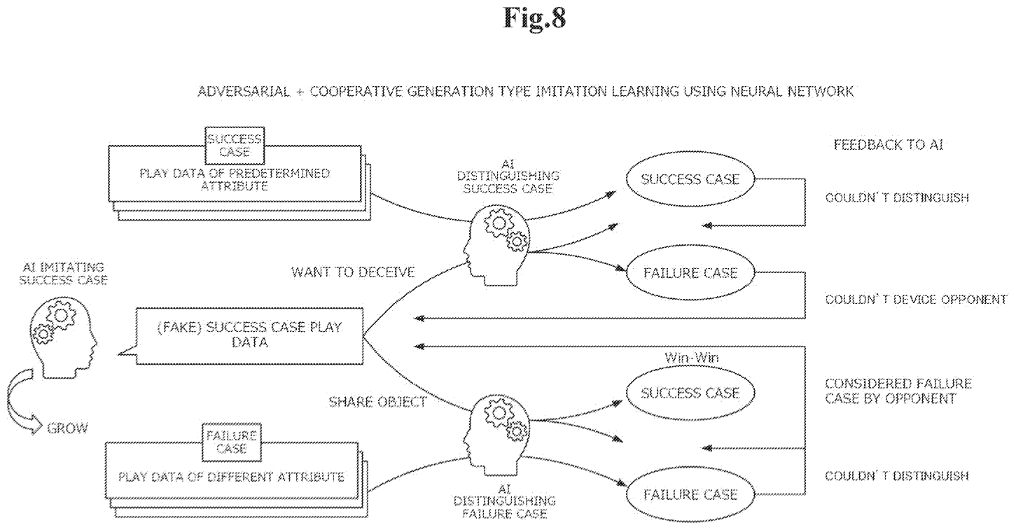

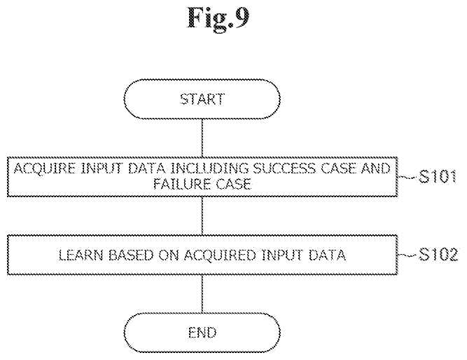

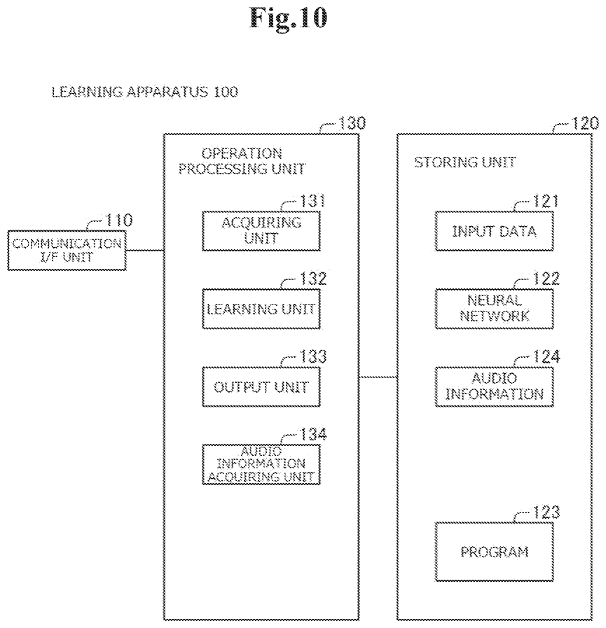

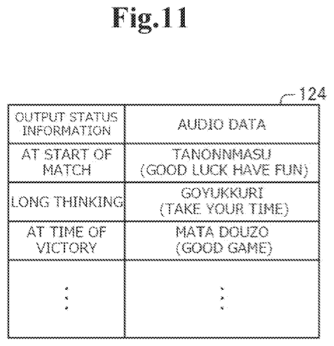

A first example embodiment of the present disclosure will be described with reference to FIGS. 1 to 11. FIG. 1 is a view for describing a learning apparatus 100. FIG. 2 is a block diagram showing an example of the configuration of the learning apparatus 100. FIG. 3 is a view showing an example of input data 121 shown in FIG. 2. FIG. 4 is a view for describing an example of an attribute. FIGS. 5 and 6 are views showing examples of play data to be collected. FIG. 7 is a view for describing another example of the play data. FIG. 8 is a view for describing an example of a learning process. FIG. 9 is a flowchart showing an example of the operation of the learning apparatus 100. FIG. 10 is a block diagram showing another example of the configuration of the learning apparatus 100. FIG. 11 is a view for describing an example of audio information.

In the first example embodiment of the present disclosure, the learning apparatus 100 (gameplay operation learning apparatus) that performs machine learning based on play data in various games including board games such as Go and Shogi and computer games such as fighting games and shooting games will be described. As shown in FIG. 1, in the case of the learning apparatus 100 in this example embodiment, a game player model for outputting an action of a learning target in response to input of a play state is generated based on play data to which a label indicating whether or not to be a learning target is assigned. That is to say, the learning apparatus 100 performs machine learning using both play data to which a label indicating a learning target is assigned and play data to which a label indicating not a learning target is assigned. Specifically, for example, a success case label that is a first label is assigned to play data having an attribute to be a learning target, and a failure case label that is a second label different from the first label is assigned to paly data having an attribute different from that of the learning target. Then, the learning apparatus 100 performs machine learning so as to get close to the play data having the attribute to be the learning target and become away from the play data having the attribute different from that of the learning target.

The learning apparatus 100 is an information processing apparatus that performs machine learning based on the play data of a game acquired from an external device and the like. The game may include board games such as Go and Shogi, computer games such as fighting games and shooting games, and any other games. For example, the learning apparatus 100 is a server apparatus and the like. The learning apparatus 100 may be a single information processing apparatus, or may be realized, for example, on the cloud.

FIG. 2 shows an example of the configuration of the learning apparatus 100. Referring to FIG. 2, the learning apparatus 100 has, as major components, a communication I/F unit 110, a storing unit 120, and an operation processing unit 130, for example.

The communication I/F unit 110 includes a data communication circuit. The communication I/F unit 110 performs data communication with an external device and the like connected via a communication line.

The storing unit 120 is a storage device such as a hard disk or a memory. The storing unit 120 stores processing information necessary for a variety of processing by the operation processing unit 130 and a program 123. The program 123 is read and executed by the operation processing unit 130 to realize various processing units. The program 123 is loaded in advance from an external device or a recording medium via a data input/output function such as the communication I/F unit 110 and stored into the storing unit 120. Major information stored in the storing unit 120 includes, for example, input data 121 and a neural network 122.

The input data 121 includes play data indicating an action taken by a player in a game, the state of the game, and so forth. The input data 121 is acquired for learning from an external device or the like via the communication I/F unit 110 or the like.

FIG. 3 shows an example of the input data 121. As shown in FIG. 3, the input data 121 includes play data of a predetermined attribute to which the success case label is assigned and play data of an attribute different from the predetermined attribute to which the failure case label is assigned. For example, the input data 121 includes a plurality of play data to which the success label is assigned and a plurality of play data to which the failure case label is assigned.

The attribute indicates information corresponding to a player who plays a game, the characteristics of the player, and the like, such as the type and proficiency of the player. FIG. 4 shows an example of the attribute. Referring to FIG. 4, the attribute may include, for example, a player attribute, a proficiency attribute, a person attribute, and a specific person attribute. Specifically, for example, the player attribute indicates the type of a player, such as whether a player is a human or AI (artificial intelligence). The proficiency attribute indicates the proficiency of a player in a game, such as advanced, intermediate, beginner, xx dan (level), and professional. The person attribute indicates information corresponding to a player, such as address and gender. The specific person attribute indicates a specific person or individual, such as Professional A or YouTuber B. The specific person attribute may be, for example, an identifier uniquely given to an individual.

Play data has attributes corresponding to the characteristics of a player who plays a game as illustrated above. Meanwhile, the attributes may be those corresponding to the characteristics of play data such as a specific action is taken many times within a predetermined time period, instead of the characteristics of a player or along with the characteristics of a player.

Further, a label indicating whether or not to be a learning target is assigned in advance to play data by an external device, for example. Specifically, for example, a success case label that is a first label is assigned to play data having an attribute to be a learning target, and a failure case label that is a second label different from the first label is assigned to play data having an attribute different from an attribute to be a learning target. A failure case label may be assigned to play data having an attribute that is contrary to an attribute to be a learning target, rather than a simply different attribute.

As an example, in a case where a success case label is assigned to play data of an advanced player, a failure case label is assigned to play data having an attribute different from that of an advanced player, such as an attribute of an intermediate player or a beginner. In a case where a success case label is assigned to play data of an advanced player, a failure case label may be assigned to play data having an attribute opposite that of an advanced player, such as an attribute of a beginner. In a case where a success case label is assigned to play data having a specific person attribute indicating a specific person such as professional A, a failure case label may be assigned to play data that does not have a specific person attribute indicating a specific person. In the respective examples described above, a failure case label may be assigned to play data having a player attribute indicating that the player is not a human but AI. By assigning a failure case label to play data having a player attribute indicating AI, it becomes possible to perform a machine learning process so as to become away from an AI-like, namely, non-human-like action. For example, by assigning a success case label to play data having a specific person attribute indicating a specific person and assigning a failure case label to play data having a player attribute indicating AI, it becomes possible to update the weight value of the neural network 122 and so forth so as to get closer to play data of the specific person and become away from a non-human-like action.

In the case of this example embodiment, an attribute to be a learning target may be identified by any means. In addition, instead of assigning a label in advance, the learning apparatus 100 may be configured to assign a label to play data based on information showing an attribute acquired in addition to play data, information showing an attribute to be a learning target, and the like.

Further, play data included by the input data 121 shows an action taken by a player in a game, the state of a game, and so forth. For example, play data includes state information showing a game state in a game (first play state), behavior information indicating an action taken by a player in the state, and so forth.

As an example, FIG. 5 shows an example of play data in a case where a played game is a fighting game. Referring to FIG. 5, play data includes information for each target that is a character to fight with. State information includes at least one of: character information showing identification information for identifying a character to fight with, remaining physical strength of the character, and so forth; position information showing position coordinates indicating the position of the character, orientation information indicating the orientation, and so forth; and motion information showing a movement speed indicating a speed at which the character moves, information indicating a behavior during action of the character, and so forth. Moreover, behavior information includes key information indicating a key input by the player. The play data may include information other than those illustrated above.

Further, as another example, FIG. 6 shows an example of play data in a case where a played game is Shogi. Referring to FIG. 6, play data includes information of two players who play Shogi. State information includes at least one of piece position information indicating the positions of pieces, captured piece information indicating the types of captured pieces, remaining time information indicating the remaining time, and so forth. Moreover, behavior information includes at least one of piece type information indicating the type of a moved piece, pre-position information indicating the position before movement of the moved piece, post-position information indicating the position after the movement, consumed time information indicating the time consumed before the movement of the piece, and so forth. The play data may include information other than those illustrated above.

Thus, the input data 121 includes play data corresponding to a game to be a learning target. Meanwhile, the input data 121 may include play data in individual scenes, respectively, or may include play data as time-series data in which states and behaviors are chained as shown in FIG. 7. Moreover, for example, play data may include a first play state in a game, an action in the first play state, and a third play state to which the state transits as a result of the action. By using the time-series data as a learning target, it is possible to perform adjustment of a weight value and the like so as to enable more proper output.

The neural network 122 is subjected to a machine learning process using the input data 121 and the like that is training data so as to output behavior information corresponding to state information and the like when play data including the state information is input. In other words, the neural network 122 is subjected to a machine learning process so as to output an action of a learning target in response to input of a second play state.

The operation processing unit 130 has an arithmetic logic unit such as a CPU (Central Processing Unit) and a peripheral circuit thereof. The operation processing unit 130 reads the program 123 from the storage unit 120 and executes the program 123 to make the abovementioned hardware and the program 123 cooperate with each other and realize various processing units. Major processing units realized by the operation processing unit 130 include, for example, an acquiring unit 131, a learning unit 132, and an output unit 133.

The acquiring unit 131 acquires play data and so forth from an external device or the like. For example, the acquiring unit 131 acquires, in addition to play data, information indicating the attribute of the play data, and so forth. Moreover, the acquiring unit 131 stores the acquired play data and so forth as the input data 121 into the storing unit 120.

Further, the acquiring unit 131 can acquire information indicating an attribute to be a learning target, and so forth. For example, the acquiring unit 131 may acquire, in addition to play data, information indicating an attribute to be a learning target, and so forth, or may acquire information indicating an attribute to be a learning target, and so forth, at a different timing from that of play data.

The learning unit 132 performs machine learning for outputting an action of a learning target in response to input of the second play state based on the input data 121 that includes play data including the first play state and an action and a label. For example, the learning unit 132 inputs the input data 121 that is training data into the neural network 122. Then, the learning unit 132 updates a weight value and the like of the neural network 122 so as to get close to play data to which a success case label is assigned and become away from play data to which a failure case label is assigned. For example, the learning unit 132 repeats the above processing using a number of training data to generate a game player model that is a created model corresponding to an attribute to be a learning target. The learning unit 132 may perform a machine learning process using a known means.

As an example, for example, as shown in FIG. 8, by making AI that imitates a success case compete with AI that distinguishes an actual success case and making the AI imitating a success case cooperate with AI that distinguishes an actual failure case, the learning unit 132 may perform training such as update of the weight value. Herein, the AI imitating a success case may be adjusted by, for example, performing imitation learning based on play data to which a success case label is assigned included by the input data 121. Moreover, the AI distinguishing an actual success case may be adjusted by performing machine learning so as to distinguish a success case based on play data to which a success case label is assigned included by the input data 121. Moreover, the AI distinguishing an actual failure case may be adjusted by performing machine learning so as to distinguish a failure case based on play data to which a failure case label is assigned included by the input data 121. Moreover, as shown in FIG. 8, by providing feedback to the respective AIs based on the result of causing the AI distinguishing a success case and the AI distinguishing a failure case to distinguish play data generated by the AI imitating a success case, the learning unit 132 may adjust the respective AIs. For example, as described above, the learning unit 132 may be configured to perform machine learning based on the input data 121 that is training data by performing adversarial and cooperative generation type imitation learning using neural network as an example. Specifically, for example, the learning unit 132 may perform a machine learning process using the method described in Non-Patent Literature 1. Meanwhile, the learning method by the learning unit 132 is not limited to the case illustrated above. The learning unit 132 may perform machine learning based on the input data 121 using a known method other than that illustrated above.

Further, the learning unit 132 may be configured to generate training data by assigning a label to play data based on information indicating an attribute to be a learning target acquired by the acquiring unit 131. For example, the learning unit 132 can assign a success case label to play data having an attribute to be a learning target, and assign a failure case label to play data having an attribute different from the attribute to be the learning target. The learning unit 132 may assign a failure case label to play data having an attribute contrary to the attribute to be the learning target among play data having an attribute different from the attribute to be the learning target. Which attribute and which attribute are contrary to each other may be determined in advance or may be determined by the learning unit 132 by any means, for example.

The output unit 133 outputs a game player model and the like that is the result of learning by the learning unit 132. For example, the output unit 133 can output the above gameplay model and the like to an external device or the like via the communication I/F unit 110 and the like.

The above is an example of the configuration of the learning apparatus 100. Subsequently, an example of the operation of the learning apparatus 100 will be described with reference to FIG. 9.

FIG. 9 shows an example of the operation of the learning apparatus 100. Referring to FIG. 9, the acquiring unit 131 acquires play data and the like from an external device or the like (step S101). Moreover, the acquiring unit 131 stores the acquired play data and the like as the input data 121 into the storing unit 120.

The learning unit 132 inputs the input data 121 that is training data to the neural network 122. Then, the learning unit 132 updates the weight value and the like of the neural network 122 so as to get close to play data to which a success case label is assigned and become away from play data to which a failure case label is assigned. For example, the learning unit 132 performs a machine learning process based on the input data 121 as described above (step S102). Meanwhile, the processing at step S101 and the processing at step S102 do not need to be necessarily consecutive.

Thus, the learning apparatus 100 has the learning unit 132. With such a configuration, the learning unit 132 can perform a machine learning process based on the input data 121 including play data having a specific attribute to be a learning target and play data having an attribute different from the learning target. That is to say, the learning unit 132 can perform a machine learning process using both play data to which a label indicating a learning target is assigned and play data to which a label indicating not a learning target is assigned. As a result, compared with the case of performing machine learning based on play data having a specific attribute to be a learning target alone, it is possible to perform machine learning based on more play data. Consequently, for example, even if it is difficult to collect enough play data having a specific attribute, it is possible to properly perform learning to get close to a learning target.

Meanwhile, the configuration of the learning apparatus 100 is not limited to the case illustrated in FIG. 2. For example, FIG. 10 shows another example of the configuration of the learning apparatus 100. Referring to FIG. 10, the operation processing unit 130 of the learning apparatus 100 can realize, in addition to the configuration illustrated in FIG. 2, an audio information acquiring unit 134 by executing the program 123.

The audio information acquiring unit 134 acquires audio information representing the voice of a specific person. Then, the audio information acquiring unit 134 stores the acquired audio information as audio information 124 into the storing unit 120. For example, when the acquiring unit 131 acquires play data, the audio information acquiring unit 134 acquires information representing voice having the same specific person attribute as the play data. In a case where information indicating an attribute to be a learning target, and the like, at a different timing from the play data, the audio information acquiring unit 134 may acquire the information representing voice at the timing when the information indicating an attribute to be a learning target, and the like, is acquired.

FIG. 11 shows an example of the audio information 124. Referring to FIG. 11, in the audio information 124, output status information indicating the status of outputting audio and audio data are associated with each other for each attribute such as a specific person attribute. For example, in the case of FIG. 11, audio data of “Goyukkuri (Take your time)” is associated with a status of “long thinking”.

In a case where the audio information 124 is included in the storing unit 120, when outputting a game player model that is the result of learning by the learning unit 132, and the like, the output unit 133 can output the audio information 124 corresponding to a learning target in addition to the game player model. Consequently, an external device or the like receiving the audio information 124 can use the result of learning by the learning unit 132 and also output audio based on the audio information 124, for example. As a result, for example, it is possible to provide a communication experience in an external device or the like as if a player is playing with a player imitated by AI.

### Second Example Embodiment

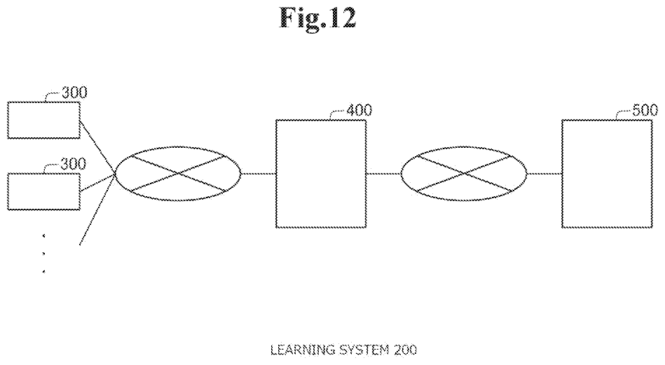

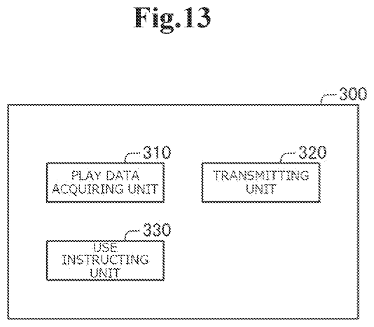

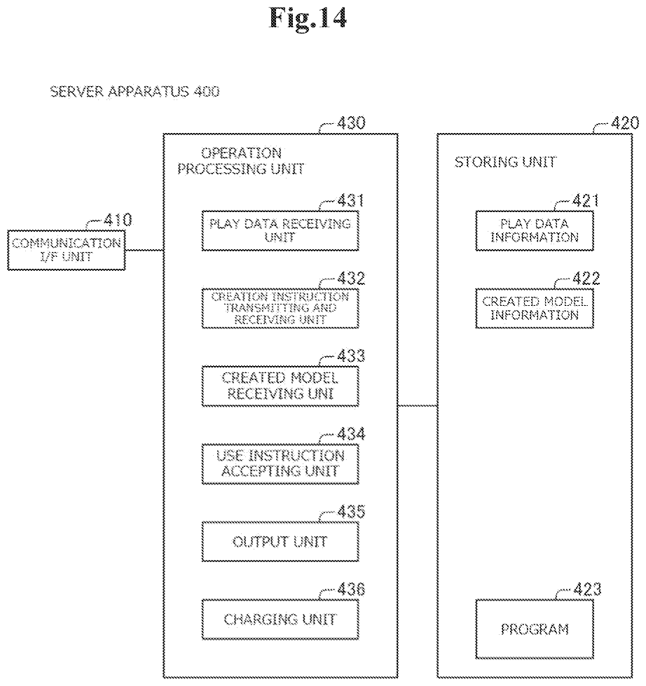

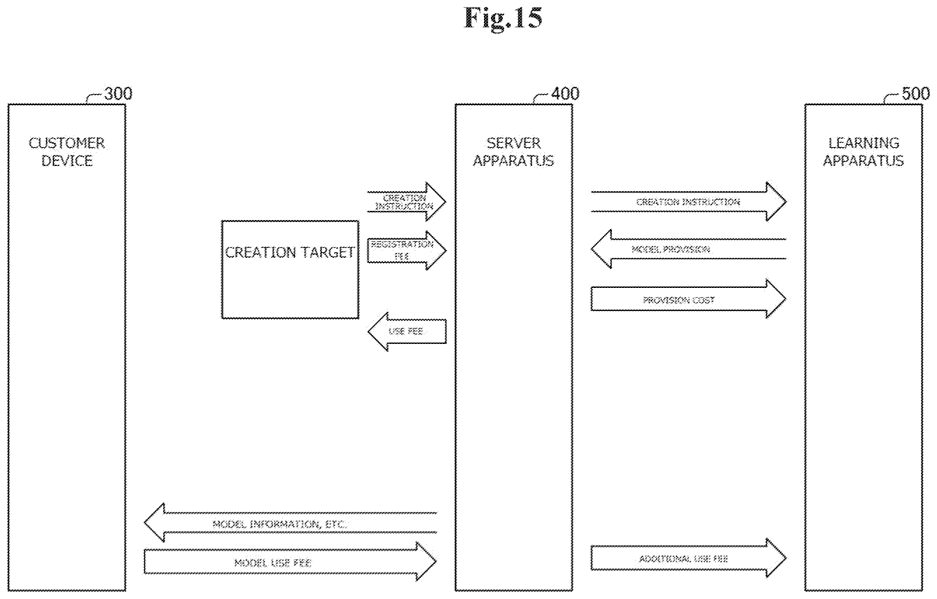

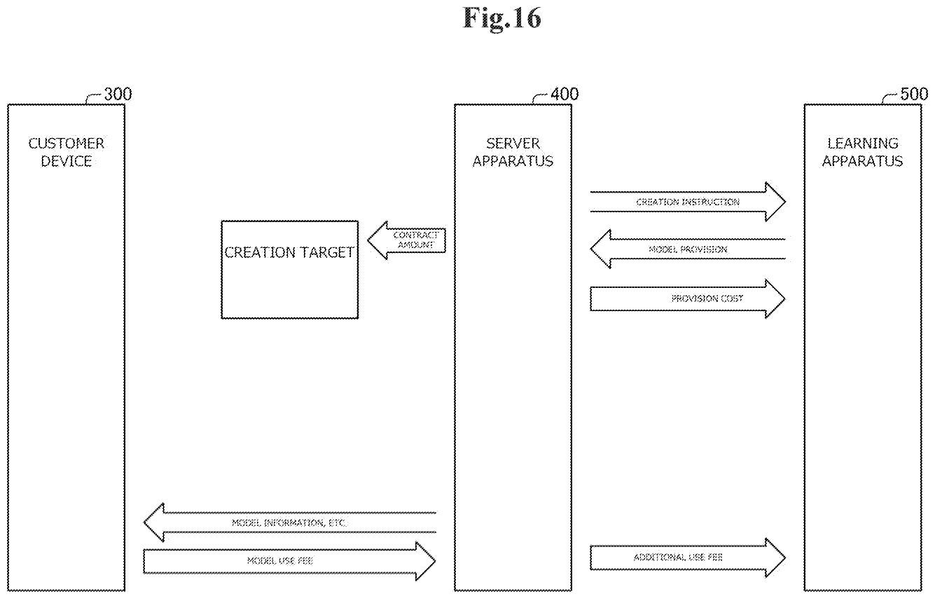

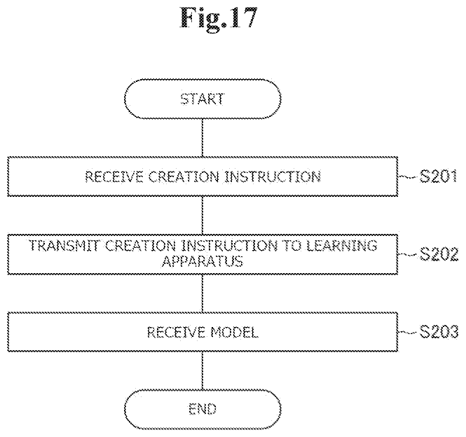

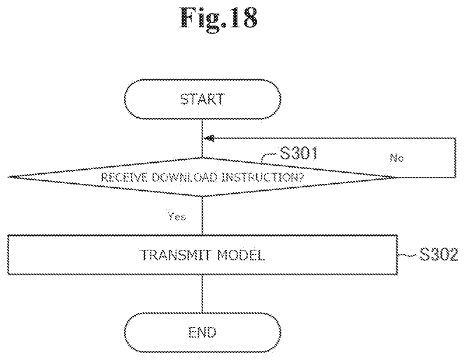

Next, a second example embodiment of the present invention will be described with reference to FIGS. 12 to 18. FIG. 12 is a view showing an example of the configuration of a learning system 200. FIG. 13 is a block diagram showing an example of the configuration of a customer device 300. FIG. 14 is a block diagram showing an example of the configuration of a server apparatus 400. FIGS. 15 and 16 are views for describing an example of a charging process. FIGS. 17 and 18 are flowcharts showing an example of the operation of the server apparatus.

In the second example embodiment of the present disclosure, the learning system 200 is described that includes a learning apparatus 500 having the same function as the learning apparatus 100 described in the first example embodiment. As will be described later, in this example embodiment, the learning apparatus 500 performs machine learning so as to get close to play data of a specific person such as a professional like an e-sports player, a YouTuber, or an entertainer, by using the same method as the learning apparatus 100 described in the first example embodiment.

FIG. 12 shows an example of the configuration of the learning system 200. Referring to FIG. 12, the learning system 200 has a plurality of customer devices 300, the server apparatus 400 serving as a game player model use provision apparatus, and the learning apparatus 500. As shown in FIG. 12, the customer devices 300 and the server apparatus 400 are connected so as to be able to communicate with each other via a network or the like. The server apparatus 400 and the learning apparatus 500 are connected so as to be able to communicate with each other via a network or the like.

The customer device 300 is an information processing apparatus on which a player plays a game. For example, the customer device 300 may be any information processing apparatus such as a video game apparatus that runs a video game, a personal computer, and a tablet device.

FIG. 13 shows a configuration of the customer device 300 characteristic of this example embodiment. Referring to FIG. 13, the customer device 300 has a play data acquiring unit 310, a transmitting unit 320, and a use instructing unit 330, in addition to a configuration necessary for executing a game. For example, the customer device 300 has an arithmetic logic unit such as a CPU and a memory unit. For example, the customer device 300 can realize the respective processing units described above by execution of a program stored in the memory unit by the arithmetic logic unit.

When a player plays a game, the play data acquiring unit 310 acquires play data showing an action taken by the player in the game, the state of the game, and so forth. The play data acquiring unit 310 may acquire the play data at predetermined intervals, or may acquire the play data when a predetermined condition is satisfied, such as when the player takes an action. Moreover, the play data acquiring unit 310 may acquire the play data as time-series data in which states and behaviors are chained. The play data acquired by the play data acquiring unit 310 may be stored in the memory unit included by the customer device 300.

The transmitting unit 320 transmits the play data acquired by the play data acquiring unit 310 to the server apparatus 400. The transmitting unit 320 may transmit, in addition to the play data, information indicating the attribute of the player stored in advance in the customer device 300, and the like, to the server apparatus 400. For example, the transmitting unit 320 can transmit the play data and the like to the server apparatus 400 at any timing.

The use instructing unit 330 instructs the server apparatus 400 to allow use of a game player model and the like corresponding to the result of learning corresponding to a specific person attribute indicating a specific person. In other words, the use instructing unit 330 transmits a use instruction indicating that a request for transmission of model information and the like necessary for allowing use of a game player model in the customer device 300 to the server apparatus 400. For example, in response to input from a player operating the customer device 300, the use instructing unit 330 instructs the server apparatus 400 to allow use of a game player model and the like indicated by the input from the player.

The server apparatus 400 is an information processing apparatus that accumulates play data and accumulates game player models. Moreover, the server apparatus 400 accepts a learning instruction to instruct the learning apparatus 500 to perform learning corresponding to a specific person attribute indicating a specific person, and transmits a game player model or model information and the like for using a game player model to the customer device 300 in response to an instruction from the customer device 300. The server apparatus 400 may be a single information processing apparatus, or may be realized on the cloud, for example.

FIG. 14 shows an example of the configuration of the server apparatus 400. Referring to FIG. 14, the server apparatus 400 has, as major components, a communication I/F unit 410, a storing unit 420, and an operation processing unit 430, for example.

The communication I/F unit 410 includes a data communication circuit and the like. The communication I/F unit 410 performs data communication with an external device and the like connected via a communication line.

The storing unit 420 is a storage device such as a hard disk or a memory. The storing unit 420 stores processing information necessary for a variety of processing in the operation processing unit 430 and a program 423. The program 423 is loaded and executed by the operation processing unit 430 to realize various processing units. The program 423 is loaded in advance from an external device or a recording medium via a data input/output function such as the communication I/F unit 410, and stored in the storing unit 420. Major information stored in the storing unit 420 includes, for example, play data information 421 and created model information 422. The storing unit 420 may store information corresponding to the audio information 124 described in the first example embodiment.

The play data information 421 includes play data received from the customer device 300. For example, in the play data information 421, play data and an attribute corresponding to the play data are associated with each other and stored. The details of the play data and the attribute may be the same as in the first example embodiment.

The created model information 422 includes a game player model that is a created model having been created by performing a machine learning process in the learning apparatus 500. For example, in the created model information 422, a game player model and information indicating an attribute to be a learning target when the game player model is created are associated with each other.

The operation processing unit 430 has an arithmetic logic unit such as a CPU and a peripheral circuit thereof. The operation processing unit 430 loads the program 423 from the storing unit 420 and executes the program 423 to make the above hardware and the program 423 cooperate with each other and realize various processing units. Major processing units realized by the operation processing unit 430 include, for example, a play data receiving unit 431, a creation instruction transmitting and receiving unit 432, a created model receiving unit 433, a use instruction accepting unit 434, an output unit 435, and a charging unit 436.

The play data receiving unit 431 receives play data and information indicating an attribute from the customer device 300. Moreover, the play data receiving unit 431 stores the received information as play data information 421 into the storing unit 420.

The creation instruction transmitting and receiving unit 432 receives an instruction for creating a game player model from an external device such as the customer device 300. For example, the creation instruction transmitting and receiving unit 432 receives a game player model creation instruction in addition to a specific person attribute that is an attribute to be a learning target.

Further, when receiving the creation instruction, the creation instruction transmitting and receiving unit 432 identifies play data having a specific person attribute to be a learning target with reference to the play data information 421. Moreover, the creation instruction transmitting and receiving unit 432 identifies play data to which a failure case label is to be assigned with reference to the play data information 421. As described in the first example embodiment, play data to which a failure case label is to be assigned may be play data having an attribute contrary to that of play data to which a success case is assigned. Then, the creation instruction transmitting and receiving unit 432 transmits the identified play data and a game player model creation instruction to the learning apparatus 500.

Assignment of a success case label and a failure case label may be performed by the creation instruction transmitting and receiving unit 432, or may be performed by the learning apparatus 500. Moreover, the play data may be transmitted to the learning apparatus 500 in advance. In this case, the creation instruction transmitting and receiving unit 432 may omit the identification of the play data and the transmission process.

The created model receiving unit 433 receives a game player model that is a created model created in response to a creation instruction transmitted by the creation instruction transmitting and receiving unit 432, from the learning apparatus 500. That is to say, the created model receiving unit 433 receives, from the learning apparatus 500, a game player model created based on play data having an attribute to be a learning target and play data having an attribute different from that of the learning target. For example, the created model receiving unit 433 receives a game player model and information indicating an attribute having been a learning target at the time of creating the game player model. Moreover, the created model receiving unit 433 stores the variety of information having been received as the created model information 422 into the storing unit 420.

The use instruction accepting unit 434 accepts a use instruction from the customer device 300.

When the use instruction accepting unit 434 accepts a use instruction from the customer device 300, the output unit 435 identifies a game player model corresponding to the use instruction with reference to the created model information 422. Then, the output unit 435 transmits model information and the like necessary for using the identified game player model to the customer device 300. That is to say, the output unit 435 transmits, to the customer device 300, model information necessary for using a game player model that is a created model created based on play data having an attribute to be a learning target and play data having an attribute different from the learning target. The model information may be the game player model itself, or may be, for example, allowance information for allowing the customer device 300 to use the game player model by accessing the server apparatus 400 or the like. The allowance information may have a predetermined time limit. The output unit 435 may be configured to transmit or make available, in addition to the game player model, the audio information 124 having a matching attribute.

The charging unit 436 performs a charging process on the customer device 300 or the like.

FIG. 15 shows an example of a charging process by the charging unit 436. Referring to FIG. 15, for example, when a game player model creation instruction is received from an external device such as the customer device 300 that is a creation target, the charging unit 436 can request a registration fee from the external device having transmitted the creation instruction. For example, the creation instruction transmitting and receiving unit 432 can be configured to transmit a game player model creation instruction and so forth to the learning apparatus 500 on the condition that a registration fee is received by the charging unit 436. The registration fee may be, for example, a predetermined amount. Moreover, when the output unit 435 transmits model information and the like to the customer device 300 in response to a use instruction from the customer device 300, the charging unit 436 can request a model use fee from the customer device 300. That is to say, the charging unit 436 can request a model use fee from the customer model 300 that uses a game player model. For example, the output unit 435 can be configured to transmit model information and the like to the customer device 300 on the condition that the charging unit 436 receives the model use fee. The model use fee may be, for example, a predetermined amount.

Further, the charging unit 436 can be configured to pay a model use fee to an external device such as the customer device 300 having transmitted a game player model creation instruction in accordance with the number of availabilities of game player model. For example, the charging unit 436 may be configured to check the number of availabilities of game player model at predetermined intervals to check whether or not a model use fee is to be paid. The model use fee may vary so as to become higher as the number of uses of game player model increases, up to the upper limit of a predetermined amount, for example.

Further, the charging unit 436 can pay a model provision cost to the learning apparatus 500, for example, when the created model receiving unit 433 receives a game player model from the learning apparatus 500, or when the creation instruction transmitting and receiving unit 432 transmits a game player model creation instruction and so forth to the learning apparatus 500. The model provision cost may be, for example, a predetermined amount. Moreover, the charging unit 436 may pay the learning apparatus 500 an additional use fee corresponding to the number of availabilities of game player model, the number of game player model creation instructions, and the like. The additional use fee may vary so as to become higher as the number of availabilities of game player model, the number of game player model creation instructions, and the like increases, for example.

As shown in FIG. 16, the charging unit 436 may be configured to pay a contract amount to an external device such as the customer device 300 instead of or in addition to a registration fee, a model use fee, and the like. For example, the charging unit 436 may be configured to estimate the number of uses of game player model and, in accordance with the result of estimation, the name recognition of a creation target person, and so forth, choose and use the process illustrated in FIG. 15 and the process illustrated in FIG. 16. Specifically, for example, when it is determined that a predetermined condition is satisfied, such as when the estimated number of uses is equal to or greater than a predetermined value or when it is determined that the name recognition is a predetermined level or more, the charging unit 436 may determine to perform the process illustrated in FIG. 16 instead of the process illustrated in FIG. 15. That is to say, the charging unit 436 may be configured not to request a registration fee when an external device having transmitted a creation instruction satisfies a predetermined condition, such as when the estimated number of uses is equal to or more than a predetermined value or when the name recognition is equal to or more than a predetermined value. In other words, the charging unit 436 requests a registration fee only when an external device having transmitted a creation instruction satisfies a predetermined condition, such as when the estimated number of uses is less than a predetermined value or when the name recognition is less than a predetermined value. The name recognition may be calculated by any means based on any information such as the number of channel subscribers and the number of video views corresponding to a creation target person, activity history information such as awards at competitions and the like, the presence or absence of professional contracts, the number of articles in which the creation target person appears and the number of views thereof.

The above is an example of the configuration of the server apparatus 400. The server apparatus 400 may be connected to a reinforcement learning apparatus that creates AI by performing reinforcement learning that a learner learns through his/her own actions. Moreover, the server apparatus 400 may be configured to receive play data between AIs received from the reinforcement learning apparatus as play data having a player attribute “AI”. In this case, the server apparatus 400 may be configured to always identify play data having the player attribute “AI” as play data to which a failure case is assigned.

The learning apparatus 500 has the same configuration as the learning apparatus 100 described in the first example embodiment. In the case of this example embodiment, the learning apparatus 500 mainly performs machine learning so as to get close to play data having a specific person attribute. Moreover, the learning apparatus 500 performs machine learning so as to become away from play data having a failure case label.

The above is an example of the configuration of the learning system 200. Subsequently, an example of the operation of the server apparatus 400 will be described with reference to FIG. 17.

FIG. 17 shows an example of the operation of the server apparatus 400. Referring to FIG. 17, the creation instruction transmitting and receiving unit 432 receives a game player model creation instruction from an external device such as the customer device 300 (step S201). For example, the creation instruction transmitting and receiving unit 432 receives a game player model creation instruction in addition to a specific person attribute that is an attribute to be a learning target.

The creation instruction transmitting and receiving unit 432 identifies play data having a specific person attribute to be a learning target with reference to the play data information 421. Moreover, the creation instruction transmitting and receiving unit 432 identifies play data to which a failure case label is to be assigned with reference to the play data information 421. Then, the creation instruction transmitting and receiving unit 432 transmits the identified play data and the game player model creation instruction to the learning apparatus 500 (step S202). Meanwhile, the creation instruction transmitting and receiving unit 432 may be configured to transmit the gameplay model creation instruction and so forth to the learning apparatus 500 on the condition of reception of a registration fee by the charging unit 436.

The created model receiving unit 433 receives a game player model that is a created model created in response to the creation instruction transmitted by the creation instruction transmitting and receiving unit 432, from the learning apparatus 500 (step S203). For example, the created model receiving unit 433 receives the game player model, and information indicating the attribute having been the learning target at the time of creation of the game player model. Moreover, the created model receiving unit 433 stores the variety of information having been received as the created model information 422 into the storing unit 420.

Further, referring to FIG. 18, the use instruction accepting unit 434 receives a use instruction from the customer device 300 (step S301, Yes). Then, the output unit 435 identifies a game player model corresponding to the instruction with reference to the created model information 422. Then, the output unit 433 transmits the identified game player model to the customer device 300 (step S302). The output unit 435 may be configured to transmit, in addition to the game player model, the audio information 124 having a matching attribute. Moreover, the output unit 435 may be configured to transmit the game player model to the customer device 300 on the condition of reception of a model use fee by the charging unit 436.

Thus, the server apparatus 400 is configured to provide a game player model created based on play data having a specific attribute and play data having an attribute different from the abovementioned attribute. With such a configuration, it is possible to provide a customer with a gaming experience closer to a specific individual or more natural motion.

The configuration of the learning system 200 is not limited to the case illustrated in this example embodiment. For example, in this example embodiment, a case where play data is accumulated in the server apparatus 400 has been illustrated. However, play data may be accumulated in a place other than the server apparatus 400, such as the learning apparatus 500. In this case, the server apparatus 400 may only output model information without acquiring or accumulating play data. Moreover, the customer device 300, the server apparatus 400, or the like may have a function as the learning apparatus 500. Thus, the learning system 200 may employ various modified examples that have the same function as a whole system.

### Third Example Embodiment

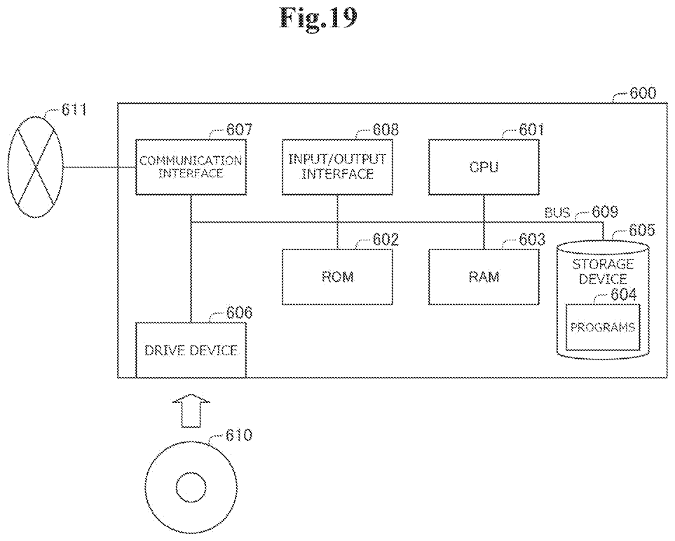

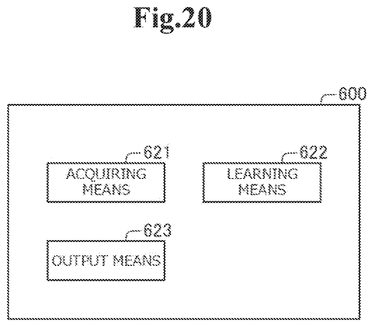

Next, a third example embodiment of the present invention will be described with reference to FIGS. 19 and 20. FIGS. 19 and 20 show an example of the configuration of a gameplay operation learning apparatus 600.

The gameplay operation learning apparatus 600 is an information processing apparatus that performs a machine learning process based on play data to which a label indicating whether or not to be a learning target is assigned. FIG. 19 shows an example of the hardware configuration of the gameplay operation learning apparatus 600. Referring to FIG. 19, the gameplay operation learning apparatus 600 has, as an example, the following hardware configuration including;
a CPU (Central Processing Unit) 601 (arithmetic logic unit),
a ROM (Read Only Memory) 602 (memory unit),
a RAM (Random Access Memory) (memory unit),
programs 604 loaded to the RAM 603,
a storage device 605 that stores the programs 604,
a drive device 605 that reads from and writes into a recording medium 610 outside the information processing apparatus,
a communication interface 607 connected to a communication network 611 outside the information processing apparatus,
an input/output interface 608 that performs input/output of data, and
a bus 609 that connects the respective components.

Further, the gameplay operation learning apparatus 600 can realize functions as an acquiring means 621, a learning means 622 and an output means 623 shown in FIG. 20 by acquisition and execution of the programs 604 by the CPU 601. The programs 604 are, for example, stored in advance in the storage device 605 or the ROM 602, and loaded to the RAM 603 or the like and executed by the CPU 601 as necessary. Moreover, the programs 604 may be supplied to the CPU 601 via the communication network 611, or may be stored in the recording medium 610 in advance and read and supplied to the CPU 601 by the drive device 606.

FIG. 19 shows an example of the hardware configuration of the gameplay operation learning apparatus 600. The hardware configuration of the gameplay operation learning apparatus 600 is not limited to the above case. The gameplay operation learning apparatus 600 may be configured by part of the above configuration, for example, without the drive device 606.

The acquiring means 621 acquires play data including a first play state in a game and an action taken by a player in the first play state, and a label indicating whether or not to be a learning target.

The learning means 622 generates a game player model for outputting an action of a learning target in response to input of a second play state based on the play data and the label.

The output means 623 outputs the game player model.

Thus, the gameplay operation learning apparatus 600 has the learning means 622. With such a configuration, the learning means 622 can generate a game player model for outputting an action of a learning target in response to input of a second play state based on play data and a label.

That is to say, the learning means 622 can perform a machine learning process using both play data to which a label indicating a learning target is assigned and play data to which a label indicating not a learning target is assigned. As a result, the learning means 622 can perform machine learning based on more play data compared with the case of performing machine learning simply based on play data having a specific attribute to be a learning target. Consequently, even if it is difficult to collect enough play data having a specific attribute, it is possible to properly perform learning for getting close to a learning target.

The gameplay operation learning apparatus 600 described above can be realized by installation of a predetermined program into an information processing apparatus such as the gameplay operation learning apparatus 600. Specifically, a program as another aspect of the present invention is a program for causing an information processing apparatus such as the gameplay operation learning apparatus 600 to realize processes to: acquire play data including a first play state in a game and an action taken by a player in the first play state, and a label indicating whether or not to be a learning target; and generate a game player model for outputting an action of a learning target in response to input of a second play state based on the play data and the label.

Further, a gameplay operation learning method executed by an information processing apparatus such as the gameplay operation learning apparatus 600 described above is a method by an information processing apparatus such as the gameplay operation learning apparatus 600, including: acquiring play data including a first play state in a game and an action taken by a player in the first play state, and a label indicating whether or not to be a learning target; and generating a game player model for outputting an action of a learning target in response to input of a second play state based on the play data and the label.

Inventions of a program, a computer-readable recording medium on which a program is recorded and a game play operation learning method having the above configurations can achieve the object of the present invention described above because they have the same actions and effects as the game play operation learning apparatus 600.

### Fourth Example Embodiment

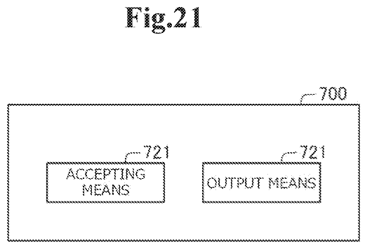

Next, a fourth example embodiment of the present invention will be described with reference to FIG. 21. FIG. 21 shows an example of the configuration of a game player model use provision apparatus 700.

The game player model use provision apparatus 700 can have the same hardware configuration as the gameplay operation learning apparatus 600 described in the third example embodiment. Moreover, the game player model use provision apparatus 700 can realize functions as an accepting means 721 and an output means 722 shown in FIG. 21 by acquisition and execution of the programs by the CPU. Meanwhile, the game player model use provision apparatus 700 may employ various modified examples in the same manner as the gameplay operation learning apparatus 600 described in the third example embodiment.

The accepting means 721 accepts a use instruction from an external device. A use instruction is an instruction for allowing an external device to use a game player model having learned an action of a learning target in a second play state. For example, a game player model having learned in advance based on play data including a first play state in a game and an action taken by a player in the first play state, and a label indicating whether or not to be a learning target.

The output means 722 outputs, in response to the use instruction accepted by the accepting means 721, model information for using the game player model indicated by the use instruction.

Thus, the game player model use provision apparatus 700 has the output means 722. With such a configuration, the output means 722 can output a game player model created by machine learning using both play data to which a label indicating a learning target is assigned and play data to which a label indicating not a learning target is assigned. As a result, it is possible to provide a customer with a game experience closer to a specific individual or attribute and closer to natural motion.

The game player model use provision apparatus 700 described above can be realized by installation of a predetermined program into an information processing apparatus such as the game player model use provision apparatus 700. Specifically, a program as another aspect of the present invention is a program for causing an information processing apparatus such as the game player model use provision apparatus 700 to realize processes to: accept a use instruction for allowing use of a game player model that has learned an action of a learning target in a second play state based on play data including a first play state in a game and an action taken by a player in the first play state, and a label indicating whether or not to be a learning target; and output, in response to the use instruction, model information for using the game player model.

Further, a game player model use provision method executed by an information processing apparatus such as the game player model use provision apparatus 700 described above is a method by an information processing apparatus such as the game player model use provision apparatus 700, including: accepting a use instruction for allowing use of a game player model that has learned an action of a learning target in a second play state based on play data including a first play state in a game and an action taken by a player in the first play state, and a label indicating whether or not to be a learning target; and outputting, in response to the use instruction, model information for using the game player model.

Inventions of a program, a computer-readable recording medium on which a program is recorded and a game player model use provision method that have the above configurations can achieve the object of the present invention described above because they have the same actions and effects as the game player model use provision apparatus 700.

### Supplementary Notes

The whole or part of the example embodiments disclosed above can also be described as the following supplementary notes. Below, the outline of a gameplay operation learning apparatus, a gameplayer model use provision apparatus and so forth in the present invention will be described. Meanwhile, the present invention is not limited to the following configurations.

### Supplementary Note 1

A gameplay operation learning apparatus comprising:
an acquiring means that acquires play data including a first play state in a game and an action taken by a player in the first play state, and a label indicating whether or not to be a learning target;
a learning means that generates a game player model for outputting an action of the learning target in response to input of a second play state based on the play data and the label; and
an output means that outputs the game player model.

### Supplementary Note 2

The gameplay operation learning apparatus according to Supplementary Note 1, wherein:
the label is either a first label or a second label, the first label being assigned to play data having an attribute to be a learning target, the second label being different from the first label and assigned to play data having an attribute different from the learning target; and
the learning means performs machine learning using the play data to which the first label is assigned and the play data to which the second label is assigned.

### Supplementary Note 3

The gameplay operation learning apparatus according to Supplementary Note 1 or 2, wherein:
the label is either a first label or a second label, the first label being assigned to play data having an attribute to be a learning target, the second label being different from the first label and assigned to play data having an attribute contrary to the attribute to be the learning target; and
the learning means performs machine learning using the play data to which the first label is assigned and the play data to which the second label is assigned.

### Supplementary Note 4

The gameplay operation learning apparatus according to Supplementary Note 2 or 3, wherein
the learning means performs machine learning so as to get close to the play data to which the first label is assigned and become away from the play data to which the second label is assigned.

### Supplementary Note 5

The gameplay operation learning apparatus according to any one of Supplementary Notes 2 to 4, wherein:
the second label is assigned to play data having an attribute indicating that a player is artificial intelligence; and
the learning means performs machine learning using the play data to which the first label is assigned and the play data having the attribute indicating that the player is artificial intelligence.

### Supplementary Note 6

The gameplay operation learning apparatus according to any one of Supplementary Notes 2 to 5, wherein
the first label is assigned to play data having an attribute indicating that a player is a specific person.

### Supplementary Note 7

The gameplay operation learning apparatus according to any one of Supplementary Notes 1 to 6, comprising
an audio information acquiring means that acquires audio information indicating player's voice,
wherein the output means outputs the audio information.

### Supplementary Note 8

The gameplay operation learning apparatus according to any one of Supplementary Notes 1 to 7, wherein
the play data includes the first play state, the action taken by the player in the first play state, and a third play state to which it shifts as a result of the action.

### Supplementary Note 9

A gameplay operation learning method by an information processing apparatus, the method comprising:
acquiring play data including a first play state in a game and an action taken by a player in the first play state, and a label indicating whether or not to be a learning target; and generating a game player model for outputting an action of the learning target in response to input of a second play state based on the play data and the label.

### Supplementary Note 10

A non-transitory computer-readable recording medium on which a program is recorded, the program comprising instructions for causing an information processing apparatus to realize processes to:
acquire play data including a first play state in a game and an action taken by a player in the first play state, and a label indicating whether or not to be a learning target; and generate a game player model for outputting an action of the learning target in response to input of a second play state based on the play data and the label.

### Supplementary Note 11

A game player model use provision apparatus comprising:
an accepting means that accepts a use instruction to make a game player model available, the game player model having learned an action of a learning target in a second play state based on play data including a first play state in a game and an action taken by a player in the first play state and based on a label indicating whether or not to be a learning target; and
an output means that outputs model information for using the game player model in response to the use instruction.

### Supplementary Note 12

The game player model use provision apparatus according to Supplementary Note 11, comprising
a charging means that requests a model use fee from an apparatus that uses the game player model.

### Supplementary Note 13

The game player model use provision apparatus according to Supplementary Note 12, comprising
an instructing means that instructs a learning apparatus to create the game player model in response to an instruction to create the game player model,
wherein, when receiving the instruction to create the game player model, the charging means requests a registration fee from an external device having transmitted the instruction to create.

### Supplementary Note 14

The game player model use provision apparatus according to Supplementary Note 13, wherein
the charging means requests the registration fee in a case where the external device having transmitted the instruction to create satisfies a predetermined condition.

### Supplementary Note 15

The game player model use provision apparatus according to any one of Supplementary Notes 11 to 14, wherein
the output means further provides audio information indicating voice of a player.

### Supplementary Note 16

The game player model use provision apparatus according to any one of Supplementary Notes 11 to 15, wherein
the output means provides the game player model created in a state in which a first label is assigned to play data having an attribute to be a learning target and a second label different from the first label is assigned to play data having an attribute contrary to the attribute to be the learning target.

### Supplementary Note 17

The game player model use provision apparatus according to any one of Supplementary Notes 11 to 16, wherein
the game player model is a model generated in a state in which a first label is assigned to play data having an attribute indicating that a player is a specific person and a second label is assigned to play data having an attribute indicating that a player is artificial intelligence.

### Supplementary Note 18

The game player model use provision apparatus according to any one of Supplementary Notes 11 to 17, wherein
the game player model is a model generated by machine learning so as to get close to play data to which a first label is assigned and become away from play data to which a second label is assigned.

### Supplementary Note 19

A game player model use provision method by an information processing apparatus, the method comprising:
accepting a use instruction to make a game player model available, the game player model having learned an action of a learning target in a second play state based on play data including a first play state in a game and an action taken by a player in the first play state and based on a label indicating whether or not to be a learning target; and outputting model information for using the game player model in response to the use instruction.

### Supplementary Note 20

A non-transitory computer-readable recording medium on which a program is recorded, the program comprising instructions for causing an information processing apparatus to realize processes to:
accept a use instruction to make a game player model available, the game player model having learned an action of a learning target in a second play state based on play data including a first play state in a game and an action taken by a player in the first play state and based on a label indicating whether or not to be a learning target; and output model information for using the game player model in response to the use instruction.

Although the invention of this application has been described with reference to the respective example embodiments, the invention of this application is not limited to the example embodiments described above. The configurations and details of the invention of this application can be changed in various manners that can be understood by one skilled in the art within the scope of the present invention.

### REFERENCE SIGNS LIST

100 learning apparatus
110 communication I/F unit
120 storing unit
121 input data
122 neural network
123 program
124 audio information
130 operation processing unit
131 acquiring unit
132 learning unit
133 output unit
134 audio information acquiring unit
200 learning system
300 customer device
310 play data acquiring unit
320 transmitting unit
330 use instructing unit
400 server apparatus
410 communication I/F unit
420 storing unit
421 play data information
422 created model information
423 program
430 operation processing unit
431 play data receiving unit
432 creation instruction transmitting and receiving unit
433 created model receiving unit
434 use instruction accepting unit
435 output unit
436 charging unit
500 learning apparatus
600 gameplay operation learning apparatus
601 CPU
602 ROM
603 RAM
604 programs
605 storage device
606 drive device
607 communication interface
608 input/output interface
609 bus
610 recording medium
611 communication network
621 acquiring means
622 learning means
623 output means
700 game player model use provision apparatus
721 accepting means
722 output means

What is claimed is:

1. A game player model use provision apparatus comprising:
at least one memory configured to store instructions; and
at least one processor configured to execute the instructions to:
accept a use instruction to make a game player model available, the game player model having learned an action of a learning target in a second play state based on play data including a first play state in a game and an action taken by a player in the first play state and based on a label indicating whether or not to be a learning target; and
output model information for using the game player model in response to the use instruction.

2. The game player model use provision apparatus according to claim 1, wherein the at least one processor is configured to execute the instructions to
request a model use fee from an apparatus that uses the game player model.

3.The game player model use provision apparatus according to claim 2, wherein the at least one processor is configured to execute the instructions to:
instruct a learning apparatus to create the game player model in response to an instruction to create the game player, model; and
when receiving the instruction to create the game player model, request a registration fee from an external device having transmitted the instruction to create.

4. The game player model use provision apparatus according to claim 3, wherein the at least one processor is configured to execute the instructions to
the registration fee in a case where the external device having transmitted the instruction to create satisfies a predetermined condition.

5. The game player model use provision apparatus according to 1, wherein the at least one processor is configured to execute the instructions to
further provide audio information indicating voice of a player.

6. The game player model use provision apparatus according to claim 1, wherein the at least one processor is configured to execute the instructions to
provide the game player model created in a state in which a first label is assigned to play data having an attribute to be a learning target and a second label different from the first label is assigned to play data having an attribute contrary to the attribute to be the learning target.

7. The game player model use provision apparatus according to claim 1, wherein
the game player model is a model generated in a state in which a first label is assigned to play data having an attribute indicating that a player is a specific person and a second label is assigned to play data having an attribute indicating that a player is artificial intelligence.

8. The game player model use provision apparatus according to claim 1, wherein
the game player model is a model generated by machine learning so as to get close to play data to which a first label is assigned and become away from play data to which a second label is assigned.

9. A game player model use provision method by an information processing apparatus, the method comprising:
accepting a use instruction to make a game player model available, the game player model having learned an action of a learning target in a second play state based on play data including a first play state in a game and an action taken by a player in the first play state and based on a label indicating whether or not to be a learning target; and
outputting model information for using the game player model in response to the use instruction.

10. A non-transitory computer-readable recording medium on which a program is recorded, the program comprising instructions for causing an information processing apparatus to realize processes to:
accept a use instruction to make a game player model available, the game player model having learned an action of a learning target in a second play state based on play data including a first play state in a game and an action taken by a player in the first play state and based on a label indicating whether or not to be a learning target; and
output model information for using the game player model in response to the use instruction.
